(19) United States
(12) Patent Application Publication
(10) Pub. No.: US 2014/0179216 A1
(43) Pub. Date: Jun. 26, 2014

(54) Particle Containment Systems

(71) Applicant: WALTERS HEALTHCARE RESOURCES, INC., Palmer, TX (US)

(72) Inventor: Mark W. Walters, Palmer, TX (US)

(73) Assignee: Walters Healthcare Resources, Inc., Palmer, TX (US)

(21) Appl. No.: 13/723,318

(22) Filed: Dec. 21, 2012

(51) Int. Cl. B01L 1/04

(52) U.S. Cl. CPC B01L 1/04
USPC 454/187

(57) ABSTRACT

A particle containment system includes an anteroom, an air-cleaning machine, and a vent. The anteroom includes a door and a first end configured to engage an opening in a building. The air-cleaning machine is coupled to a first port formed in a first wall of the anteroom. The air-cleaning machine is configured to provide filtered air to an interior of the anteroom or filter air provided from the interior of the anteroom. The vent is coupled to a second port formed in the first wall or a second wall of the anteroom. The vent is configured to close and seal when the door of the anteroom is opened.

### BACKGROUND

This disclosure relates generally to particle containment and, more specifically, to particle containment systems that may be utilized to protect a clean area from a contaminated area.

Negative air machines may be employed to provide negative pressure for various tasks, e.g., mold abatement, disaster restoration, and renovation projects. A negative pressure environment helps to contain mold, dust, particles, and odors within a workspace containment barrier. In general, air always flows from areas of higher pressure to areas of lower pressure. As such, creating and maintaining negative pressure within a workspace containment barrier results in inward airflow through any leaks or openings in the containment barrier. In general, maintaining a negative pressure within a workspace containment barrier prevents airborne contaminants from escaping into and contaminating other parts of a building.

In order to create a negative pressure environment, more air must leave a space than enters the space. According to conventional approaches, a project area is usually walled-off with permanent or temporary barriers. One or more portable air scrubbers (that filter air and function as negative air machines) may then be deployed inside a project area. Ductwork has then been ran from the scrubbers to an area outside of the project area, typically to an area outside of the building.

Portable air scrubbers usually include filters that trap and block small particles in filtered air. For example, a portable air scrubber may employ a high-efficiency particle air (HEPA) filter. In general, a certified HEPA filter trap particles as small as 0.3 microns with 99.97 percent efficiency. HEPA filters may be used in, for example, medical research centers, atomic research centers, nuclear power plants, hospitals, pharmaceutical manufacturing, and hazardous material (HAZMAT) service contractor applications (e.g., lead paint, asbestos, anthrax, and mold abatement). HEPA filtered portable air scrubbers provide “operating-room clean” filtered air. HEPA filters are the only type of filter currently recognized by the U.S. Environmental Protection Agency (EPA) and the Center for Disease Control (CDC), as well as environmental health professionals, as being effective for capturing invisible particles and microbial spores that can potentially cause fungal infections.

One conventional containment approach has established negative air pressure by piping air out of a containment area (e.g., a construction area in a building) into a hallway of the building, which typically creates a high volume of air and noise in the hallway. Another conventional containment approach has ran ducting from a containment area through hallways of a building to an area outside of the building. This approach may introduce outside contaminants and moisture into clean areas (e.g., sterile areas) of a building. Other approaches have piped air through return air or exhaust vents, which creates the possibility of dust particles entering an air system and/or damaging a heating, ventilation, and air-conditioning (HVAC) system of a building. Containment barriers have conventionally been constructed using flimsy wall poles and plastic sheeting or sheetrock (which is dusty, can be easily punctured, and cannot readily produce an airtight seal).

### SUMMARY

A particle containment system includes an anteroom, an air-cleaning machine, and a vent. The anteroom includes a door and a first end configured to engage an opening (e.g., a door frame) in a building. The air-cleaning machine is coupled to a first port formed in a first wall of the anteroom. The air-cleaning machine is configured to provide filtered air to an interior of the anteroom or filter air provided from the interior of the anteroom. The vent is coupled to a second port formed in the first wall or a second wall of the anteroom. The vent is configured to close and seal when the door of the anteroom is opened.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a view of a particle containment system that includes an anteroom configured according to one embodiment of the present disclosure;

FIG. 2 is a view of a particle containment system that includes an anteroom configured according to another embodiment of the present disclosure;

FIG. 3 is a front view of a door-only attachment for a particle containment system that is configured according to still another embodiment of the present disclosure to provide a barrier between a clean area and a contaminated area;

FIG. 4 is a side view of the door-only attachment of FIG. 3;

FIGS. 5A-5B include front and side views, respectively, of a vent panel for a particle containment system configured according to the present disclosure;

FIG. 6 includes a view of a portion of a frame of an anteroom that includes brackets for attaching an end of the anteroom to a door frame of a building according to an embodiment of the present disclosure;

FIG. 6A includes a view of a magnetic fastener that is retained in a bracket for attaching the end of the anteroom to the door frame of the building according to one embodiment of the present disclosure; and

FIG. 7 includes a view of a modular anteroom configured according to one embodiment of the present disclosure.

### DETAILED DESCRIPTION

In the following detailed description of exemplary embodiments of the invention, specific exemplary embodiments in which the invention may be practiced are described in sufficient detail to enable those skilled in the art to practice the invention, and it is to be understood that other embodiments may be utilized and that architectural, mechanical, electrical and other changes may be made without departing from the spirit or scope of the present invention. The following detailed description is, therefore, not to be taken in a limiting sense, and the scope of the present invention is defined only by the appended claims and their equivalents.

According to one aspect of the present disclosure, a particle containment system is disclosed that includes a modular anteroom that is constructed of sturdy materials (e.g., metal tubing and acrylic panels) that advantageously provide a containment barrier that cannot be easily punctured and is readily configurable to provide an airtight seal for containing contaminants in a work area. The components of the modular anteroom system provide an airtight anteroom that may be readily sealed to the frame of an existing entry door of a building or another opening in a building. In at least one embodiment, contaminated air is pulled through an air-cleaning machine (e.g., a negative air machine with a high-efficiency particle air (HEPA) filter) into the anteroom, which creates a bubble of protection between a contaminated area (e.g., a construction area) and a clean (e.g., sterile) area. In at least one embodiment, the filtered air is released back into the contaminated area through an exhaust port, thus creating a vacuum loop that continuously cleans contaminated air. In general, the system protects the integrity of a clean area, even in the event of a power failure.

Various embodiments of the present disclosure provide a particle containment system that protects a clean (e.g., sterile) environment by sealing off a contaminated area. In one or more embodiments, an anteroom of the particle containment system magnetically seals to an existing door frame to create an airtight seal without damaging walls and/or doors. While the discussion herein is primarily directed to an anteroom that seals to an existing door frame, it should be appreciated that the anteroom may seal to another portion of a building (e.g., an opening in a wall or a ceiling). The particle containment system may be utilized to create a bubble of protection between a construction area and a clean area through the use of gaskets (e.g., between panels of an anteroom, between an end of the anteroom and a building door frame and/or other opening, and between a containment door of the anteroom and an associated door frame) that provide an airtight seal and a HEPA filter that removes particles and cleans contaminated air. In various embodiments, the system maintains a vacuum loop to prevent escape of dust and debris into a clean area. The modular design of the particle containment system allows the system to be quickly set-up and taken-down (e.g., by a single person). In various embodiments, the particle containment system is portable and can be taken apart and easily stored, moved, or shipped.

The modular design of the anteroom can be customized to a size that fits the parameters of virtually any worksite. In one or more embodiments, the anteroom includes transparent, puncture resistant panels that allow viewing a worksite from within a clean bubble of protection, without entering the worksite. The anteroom may, for example, include clear, fire-rated acrylic panels and sturdy powder coated metal tubular framing that can be easily cleaned and re-used multiple times. Alternatively, aluminum angle iron may be utilized to form a frame for an anteroom with transparent and/or non-transparent panels attached to the frame. In general, a particle containment system constructed according to the present disclosure is environmentally friendly in that the system creates no disposable waste.

In one embodiment, contaminated air is pulled through a HEPA filter of a negative air machine at a rate of 2000 cubic feet per minute (CFM), distributing air that is 99.9% sterile. A vacuum is created in a construction area (or contaminated area), opening an exhaust port of the anteroom to create a vacuum loop that distributes clean air back into the contaminated area. When a containment door of the anteroom is opened, the exhaust port closes and an airtight seal is formed with clean air flowing through the doorway from the anteroom, maintaining a vacuum loop.

According to another aspect of the present disclosure, an interior of the anteroom is considered a contaminated area and an area outside the anteroom is considered a clean area. In this embodiment, normal operation of a particle containment system configured according to the present disclosure creates a circulation of air that is constantly cleaning the air in the contaminated area. If an air-cleaning machine (e.g., a HEPA machine) stops working, then an intake port of the anteroom closes to provide an air tight seal to protect the clean area from contaminated air inside the anteroom. Due to the air tight seal, the only way air can flow from the contaminated area to the clean area is through the HEPA machine. When a door of the anteroom is closed, the intake port opens to allow clean air to flow into the contaminated area (since the contaminated area is at a lower pressure than the clean area). When the HEPA machine is running, isolated contaminated air is pulled into the HEPA machine. When anteroom door is closed, the intake port opens to allow clean air to be pulled from the clean area into the contaminated area.

According to another aspect of the present disclosure, a particle containment system may be configured to employ a door-only attachment. The door-only attachment advantageously reduces a footprint of the particle containment system for situations where footprint is an issue. In this case, the door-only attachment includes an intake port whose hinged intake port cover opens (inward into the contaminated area) to pull clean air (from a clean area) into the contaminated area. The intake port closes and seals if a HEPA machine (located in the contaminated area) is shut-off. The HEPA machine filters contaminated air from the contaminated area and releases clean air into the clean area (e.g., a hallway) via an exhaust port.

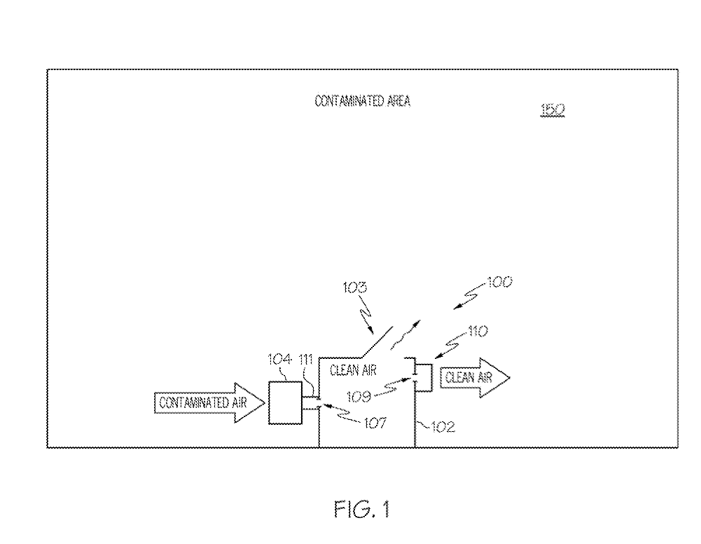

With reference to FIG. 1, an exemplary particle containment system 100 is illustrated that includes a modular anteroom 102 and an air-cleaning machine 104. An open section of the anteroom 102 is sealed to an existing door frame of a building or other opening in the building. For example, in buildings that employ metal door frames, the open end of the anteroom 102 may be held in engagement with a building door frame with a numbers of magnets that are mechanically retained in brackets attached along portions of the open end. As another example, the open end of the anteroom 102 may be held in engagement with a building door frame with a numbers of fasteners that mechanically retain brackets attached along portions of the open end in contact with the building frame.

As is illustrated in FIG. 1, the anteroom 102 includes a port 107, through which (in this embodiment) clean air is provided and a port 109 that functions an exhaust port. The port 109 is configured to receive a vent 110 that opens (into contaminated area 150) to release clean air into the contaminated area 150 when the machine 104 is operational and containment door 103 is closed. In various embodiments, containment door 103 includes an associated gasket that creates an airtight seal when containment door 103 is closed. The associated gasket may be positioned on a frame of the anteroom 102 or on an inner surface of door 103. As is illustrated, an input of the machine 104 receives contaminated air and an output of the machine 104 provides clean air to an interior of the anteroom 102, via a duct 111 that is coupled between an output of the machine 104 and the port 107.

When the door 103 is momentarily opened, the vent 110 closes and seals (i.e., creates an airtight seal) and clean air flows from the interior of the anteroom 102 through the open door 103 to the contaminated area 150 due to the pressure differential between the interior of the anteroom 102 and the contaminated area 150, thus preventing contaminated air from entering the interior of the anteroom 102. It should be appreciated that during normal operation, the system 100 is constantly cleaning contaminated air. In the event that the machine 104 ceases to operate (e.g., due to a power failure), the vent 110 closes and the anteroom 102 creates an air-tight seal such that the only way air can flow from the contaminated area 150 to the clean area is through the machine 104.

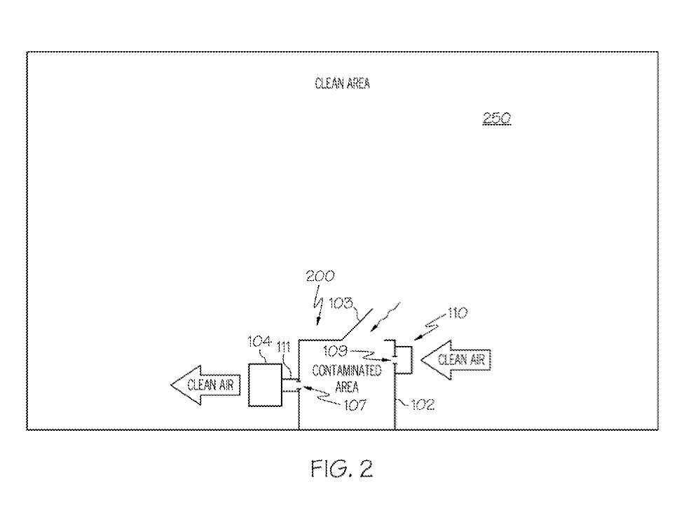

With reference to FIG. 2, an exemplary particle containment system 200 is illustrated that includes a modular anteroom 102 and an air-cleaning machine 104. As with FIG. 1, an open section of the anteroom 102 is sealed to an existing door frame of a building or another opening in the building. For example, in buildings that employ metal door frames, the open end of the anteroom 102 may be held in engagement with a building door frame with a numbers of magnets that are mechanically retained in brackets attached along portions of the open end. As another example, the open end of the anteroom 102 may be held in engagement with a building door frame with a numbers of fasteners that mechanically retain brackets attached along portions of the open end in contact with the building frame.

As is illustrated, the anteroom 102 includes a port 107, through which (in this embodiment) contaminated air is provided to an input of air-cleaning machine 104 and a port 109 that functions as an intake port. The port 109 is configured to receive a vent 110 that opens (into an interior of anteroom 102) to provide clean air into the contaminated interior of the anteroom 102 when the machine 104 is operational and door 103 is closed. As is illustrated, an input of the machine 104 receives contaminated air, via a duct 111 that is coupled between an input of the machine 104 and the port 107, and an output of the machine 104 provides clean air to clean area 250.

When the door 103 is momentarily opened, the vent 110 closes and seals and clean air is pulled through the open door 103 into the interior of the anteroom 102 (due to the pressure differential between the interior of the anteroom 102 and the clean area 250), thus preventing contaminated air from entering the clean area 250. It should be appreciated that during normal operation, the system 200 is constantly cleaning contaminated air. In the event that the machine 104 ceases to operate (e.g., due to a power failure) the vent 110 closes and the anteroom 102 creates an air-tight seal such that the only way air can flow from the contaminated interior of the anteroom 102 to the clean area 250 is through the machine 104.

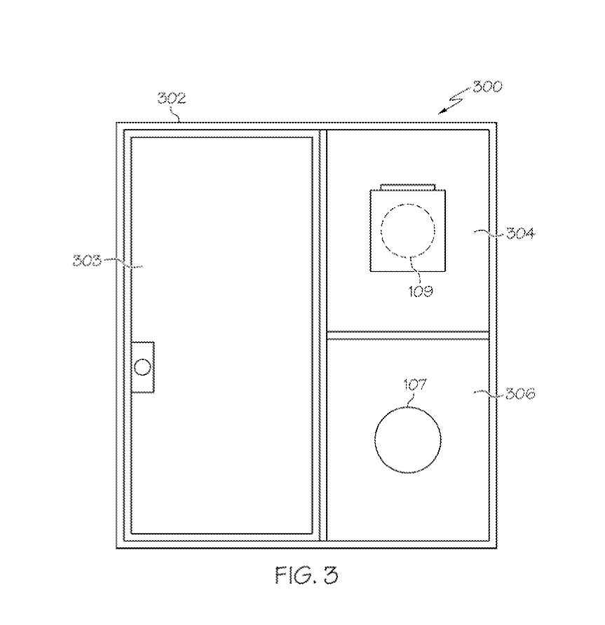

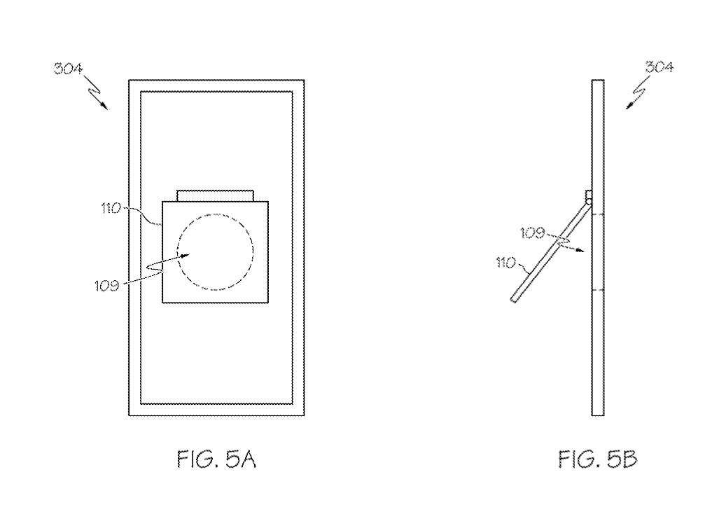

With reference to FIGS. 3, 4, 5A, and 5B, a particle containment system 300 is illustrated that includes a door-only attachment 302 with door panels 304 and 306 and an air-cleaning machine 104. The door-only attachment 302 may be sealed to an existing door frame of a building or another opening in the building. For example, in buildings that employ metal door frames, the door-only attachment 302 may be held in engagement with a building door frame with a numbers of magnets that are mechanically retained in brackets attached along portions of a frame of the door-only attachment 302. As another example, the door-only attachment 302 may be held in engagement with a building door frame with a numbers of fasteners that mechanically retain brackets attached along portions of the frame of the door-only attachment 302 in contact with the building frame.

As is illustrated, the door panel 306 includes a port 107, through which (in this embodiment) clean air is provided from an output of air-cleaning machine 104 and the door panel 304 includes a port 109 that functions as an intake port. The port 109 is configured to receive a vent 110 that opens (into an interior of contaminated area 450) to provide clean air into the contaminated area 450 when the machine 104 is operational and door 303 is closed. In one or more embodiments, the vent 110 is weighted to open at a defined pressure level.

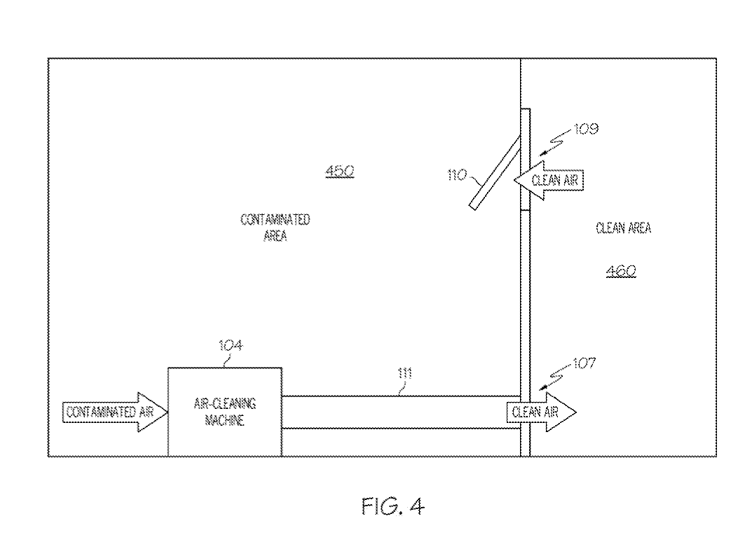

As is illustrated in FIG. 4, an input of the machine 104 receives contaminated air and an output of the machine 104 provides, via a duct 111 that is coupled between an output of the machine 104 and the port 107, clean air to clean area 460. When the door 303 is momentarily opened, the vent 110 closes and clean air is pulled through the open door 303 into contaminated area 450 due to the pressure differential between the contaminated area 450 and the clean area 460, thus preventing contaminated air from entering the clean area 460. It should be appreciated that during normal operation the system 300 is constantly cleaning contaminated air. In the event that the machine 104 ceases to operate (e.g., due to a power failure) the vent 110 closes and the door-only attachment 302 creates an air-tight seal such that the only way air can flow from the contaminated area 450 to the clean area 460 is through the machine 104.

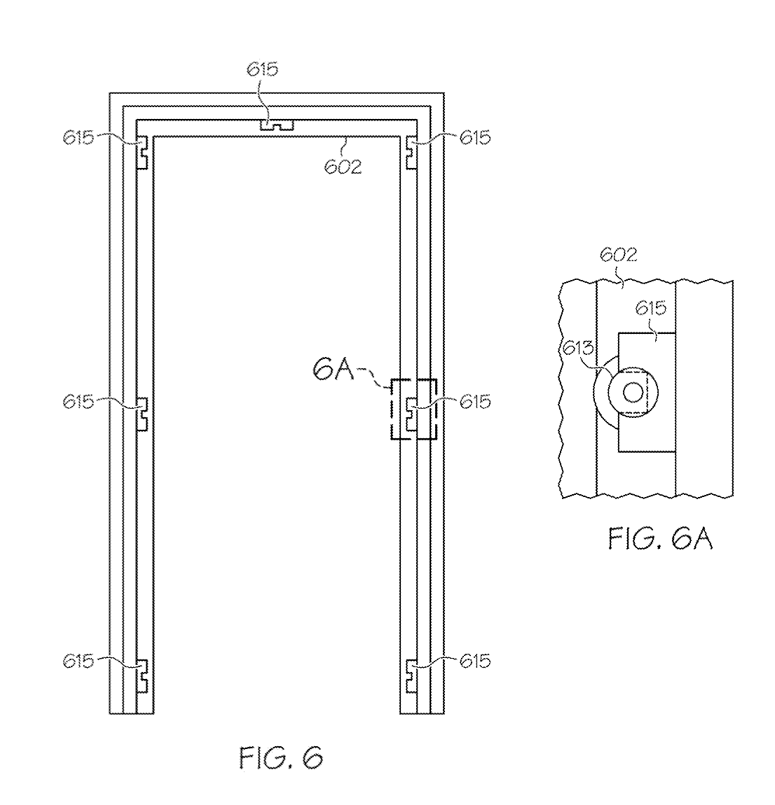

FIG. 6 includes a view of a portion of a frame of the open end of the anteroom 102, which includes brackets 615 for attaching the open end of the anteroom 102 to a door frame 602 of a building or another opening in the building. It should be appreciated that in buildings that employ metal door frames, the open end of the anteroom 102 may be held in engagement with a building door frame 602 with a numbers of magnets 613 that are mechanically retained in brackets 615 attached along portions of the open end. As another example, the open end of the anteroom 102 may be held in engagement with the building door frame 602 with a numbers of fasteners that mechanically retain brackets attached along portions of the open end in contact with the building door frame 602. Similarly, door-only attachment 302 may include a number of brackets that include apertures or slots for receiving magnets or fasteners for attaching the door-only attachment 302 to a building door frame.

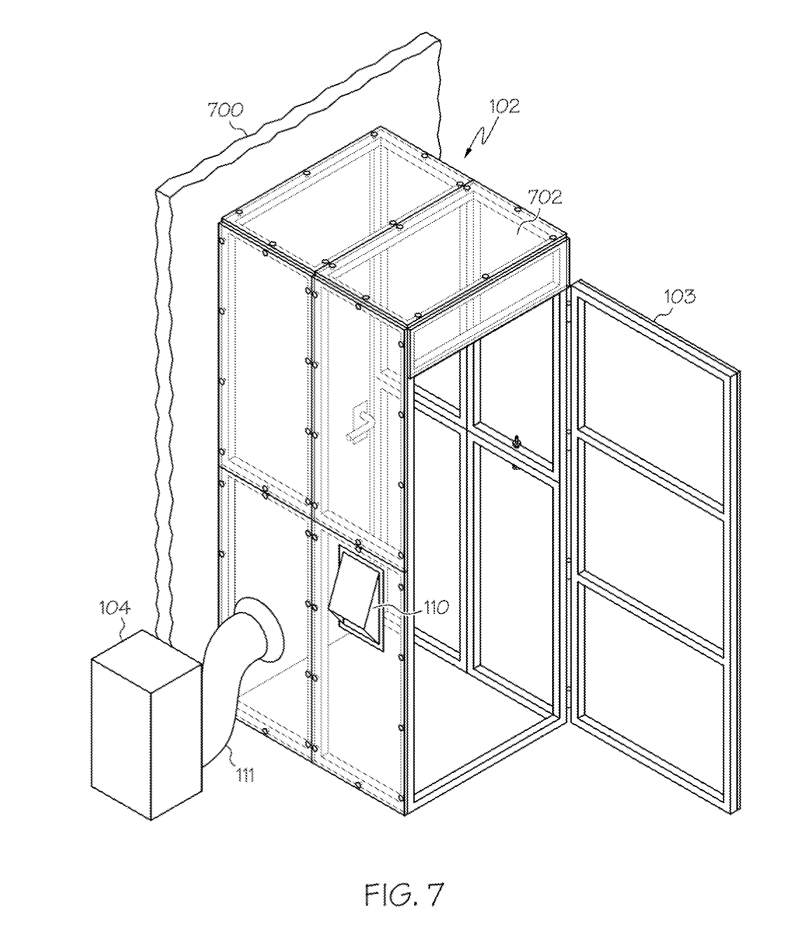

With reference to FIG. 7, the anteroom 102 may include a number of modular panels 702 that may be connected (with mechanical fasteners). In various embodiments each of the modular panels 702 includes a metal frame and a transparent panel (e.g., an acrylic panel) mechanically fastened to the frame. Alternatively, some or all of the modular panels 702 may include non-transparent panels. In one or more embodiments, seals are employed between adjacent ones of the modular panels and the transparent panels are sealed (e.g., using an adhesive or a gasket material) to their respective frames. An open end of the anteroom 102 is illustrated as being engaged with a door frame provided in a wall 700 of a building.

Accordingly, a number of particle containment systems have been described herein that advantageously prevent particles in a contaminated area from entering a clean area.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solution to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A particle containment system, comprising:
an anteroom including a door and a first end configured to engage an opening in a building;
an air-cleaning machine coupled to a first port formed in a first wall of the anteroom, wherein the air-cleaning machine is configured to provide filtered air to an interior of the anteroom or filter air provided from the interior of the anteroom; and
a vent coupled to a second port formed in the first wall or a second wall of the anteroom, wherein the vent is configured to close and seal when the door of the anteroom is opened.

2. The particle containment system of claim 1, further comprising:
one or more tabs extending from the first end; and
one or more magnetic attachments extending from the one or more tabs, wherein the magnetic attachments are configured to magnetically couple the first end of the anteroom to a door frame of the building.

3. The particle containment system of claim 2, further comprising:
one or more seals configured to seal the first end of the anteroom to the door frame when the first end is magnetically coupled to the door frame.

4. The particle containment system of claim 1, further comprising:
one or more tabs extending from the first end, wherein the one or more tabs are configured to receive fasteners for mechanically coupling the first end of the anteroom to the door frame.

5. The particle containment system of claim 4, wherein the one or more tabs include apertures or slots for receiving the fasteners.

6. The particle containment system of claim 1, wherein the anteroom further comprises:
multiple panel frames, wherein each of the multiple panel frames are configured to be mechanically coupled to one or more of the remaining ones of the multiple panel frames; and
multiple panels, wherein one of the multiple panels is coupled to each of the multiple panel frames.

7. The particle containment system of claim 6, wherein the multiple panel frames are formed from metal tubing and the multiple panels are acrylic panels.

8. The particle containment system of claim 1, wherein the air-cleaning machine is configured to provide the filtered air to the interior of the anteroom and the vent is also configured to close and seal when the air-cleaning machine loses power.

9. The particle containment system of claim 1, wherein the air-cleaning machine is configured to filter air provided from the interior of the anteroom and the vent is also configured to close and seal when the air-cleaning machine loses power.

10. A particle containment system, comprising:
an anteroom including a door and a first end configured to engage an opening in a building;
an air-cleaning machine coupled to a first port formed in a first wall of the anteroom, wherein the air-cleaning machine is configured to provide filtered air to an interior of the anteroom or filter air provided from the interior of the anteroom; and
a vent coupled to a second port formed in the first wall or a second wall of the anteroom, wherein the vent is configured to close and seal when the door of the anteroom is opened, and wherein the air-cleaning machine includes a high-efficiency particle air (HEPA) filter.

11. The particle containment system of claim 10, further comprising:
one or more tabs extending from the first end; and
one or more magnetic attachments extending from the one or more tabs, wherein the magnetic attachments are configured to magnetically couple the first end of the anteroom to a door frame of the building.

12. The particle containment system of claim 11, further comprising:
one or more seals configured to seal the first end of the anteroom to the door frame when the first end is magnetically coupled to the door frame.

13. The particle containment system of claim 10, further comprising:
one or more tabs extending from the first end, wherein the one or more tabs are configured to receive fasteners for mechanically coupling the first end of the anteroom to the door frame.

14. The particle containment system of claim 13, wherein the one or more tabs include apertures or slots for receiving the fasteners.

15. The particle containment system of claim 10, wherein the anteroom further comprises:
multiple panel frames, wherein each of the multiple panel frames are configured to be mechanically coupled to one or more of the remaining ones of the multiple panel frames; and
multiple panels, wherein one of the multiple panels is coupled to each of the multiple panel frames.

16. The particle containment system of claim 15, wherein the multiple panel frames are formed from metal tubing and the multiple panels are acrylic panels.

17. The particle containment system of claim 10, wherein the air-cleaning machine is configured to provide the filtered air to the interior of the anteroom and the vent is also configured to close and seal when the air-cleaning machine loses power.

18. The particle containment system of claim 10, wherein the air-cleaning machine is configured to filter air provided from the interior of the anteroom and the vent is also configured to close and seal when the air-cleaning machine loses power.

19. A particle containment system, comprising:
a door-only attachment including a door, wherein the door-only attachment is configured to engage an opening in a building;
an air-cleaning machine coupled to a first port formed in a first panel of the door-only attachment, wherein the air-cleaning machine is configured to filter air provided from a contaminated area; and
a vent coupled to a second port formed in the first panel or a second panel of the door-only attachment, wherein the vent is configured to close and seal when the door of the door-only attachment is opened.

20. The particle containment system of claim 19, wherein the air-cleaning machine includes a high-efficiency particle air (HEPA) filter and the vent is also configured to close and seal when the air-cleaning machine loses power.
